(19) United States
(12) Patent Application Publication
(10) Pub. No.: US 2006/0082444 A1
(43) Pub. Date: Apr. 20, 2006

(54) Management system for enhanced RFID system performance

(75) Inventors: Patrick Joseph Sweeney II, Philoment, VA (US); Earl Dale Cox JR., Morrisville, NC (US)

Correspondence Address: JUSTIN GRAY, 12003 WALNUT BRANCH RD., RESTON, VA, 20194, US

(73) Assignee: ALYSIS INTERACTIVE CORPORATION, San Francisco, CA (US)

(21) Appl. No.: 10/904,020

(22) Filed: Oct. 19, 2004

(51) Int. Cl. H04Q 5/22

(52) U.S. Cl. 340/10.3; 340/10.1; 340/572.4

(57) ABSTRACT

A method and system managing radio frequency identification (RFID) systems. The system monitors the performance of systems that use RFID tags and readers. It operates at multiple levels to ensure the optimal performance of readers, tags, antennae, and the information processing systems that acquire and convey tag data. The management system may employ artificial intelligence techniques such as genetic algorithms, fuzzy logic, neural networks, Bayesian networks, support vector machines or statistical methods to develop, maintain and exploit models of RFID system behavior. By comparing the actual performance of RFIDs and related components, the management system can detect and report failures and partial failures of components. The management system may also send signals to components to enhance performance of the overall RFID system.

### BACKGROUND OF INVENTION

This invention relates to a method and apparatus for enhancing the performance of radio frequency identification systems.

Radio Frequency ID (RFID) systems allow for the identification of objects at a distance and out of line of sight. They are comprised of transponders called radio frequency (RF) tags and RF interrogators (also called readers). The tags are generally smaller, less expensive than interrogators, and are commonly attached to objects such as product packages in stores. When an interrogator comes within range of an RF tag, it may provide power to the tag via a querying signal, or the RF tag may use stored power from a battery or capacitor to send a radio frequency signal to be read by the RFID interrogator.

RF tags may consist of single integrated circuits, circuits and antennae, or may incorporate more complex capabilities such as computation, data storage, and sensing means. Some categories of RFID tags include the following: passive tags that acquire power via the electromagnetic field emitted by the interrogator, semi-passive tags that respond similarly, but also use on-board stored power for other functions, active tags that use their own stored power to respond to an interrogator's signal, inductively coupled tags that operate at low frequencies and short distances via a coil antenna, single or dipole antenna-equipped tags that operate at higher frequencies and longer distances, read-write tags that can alter data stored upon them, full-duplex or half duplex tags, collision arbitration tags that may be read in groups, or non-collision tags that must be read individually.

RFID systems consists of RFID tags, RFID interrogators and middleware computing devices. Downstream processing of RFID signal information (such as EPC numbers, GTINs, UID numbers, etc) usually occurs in two stages. Tag responses are decoded (or demodulated) and converted to a standard packet form by the reader and sent to the middleware device. The middleware device is responsible for processing the raw information into a useful form. For instance, a reader may send many identical packets when a tag attached to an object moves along a conveyor belt past an interrogator. The middleware (or savant) reduces the chatter of the interrogator to a concise and structured stream of unique packets. These packets are then typically sent to an enterprise application that actually processes the data. Examples of such applications include those that perform inventory management, supply chain management and analysis, or purchase and backorder handling.

RFID systems present a number of advantages over other object marking and tracking systems. A radio frequency interrogator may be able to read a tag when it is not in line of sight from the interrogator, when the tag is dirty, or when a container obscures the tag. RFID systems may identify objects at greater distances than optical systems, may store information into read/write tags, do not require a human operator, and may read tags hidden from visual inspection for security purposes. These advantages make RFID systems useful for tracking objects.

As organizations strive to adopt RFID systems for tracking objects, they face challenges imposed by the nature of the objects they handle and the environments in which those objects are processed. Radio frequency signals are reflected, refracted, or absorbed by many building, packaging, or object materials. Moving people, vehicles, weather and ambient electromagnetic radiation can also effect the performance of RFID systems. Compounding the situation is a growing diversity of choices among RFID systems and components with dimensions such as cost, range, and power consumption. There is a need for a system that examines the stream of data passing through a system of RFIDs to detect failures and partial failures, to compensate for failures and to optimize performance.

U.S. Pat. Application No. 2002/0165733 A1 discloses an invention that monitors the behavior of caregivers in a hospital environment. It differs from this invention in several important regards: it does not apply to general RFID networks; it does not apply to general-purpose RFID systems; it does not monitor the performance of the RFID system; it does not detect or compensate for failures in an RFID system, nor does it remediate possible failure conditions of the network. Instead, it monitors the behavior of the people and objects in a special purpose RFID network.

U.S. Pat. Application No. 2003/0158795 A1 discloses a system for quality management and intelligent manufacturing with labels and smart tags in event-based product manufacturing. The system monitors a manufacturing process to detect alarms related to waste, machine delay, or decreases in product quality. The system does not monitor the performance of the RFID system itself. The system does not detect or compensate for failures in an RFID system, nor does it remediate possible failure conditions of the network. The system depends upon the reliable operation of an RFID to perform its functions.

U.S. Pat. Application No. 2004/0113791 A1 discloses a system for monitoring operation and performance of systems employing electronic tags such as article surveillance or RFID tags. The system differs from this invention in several regards. It is directed toward the detection of RFID deactivation failures within a retail environment. While the system gathers a log statistical information regarding tag read rates, it does not detect and isolate RFID system failures such as antenna misdirection or RFID reader failure. The system differs from this invention, also, in that it does not send signals to components of the RFID system to compensate for partial failures.

### SUMMARY OF INVENTION

This invention relates to a method and apparatus for the management of radio frequency identification (RFID) systems. The invention monitors the performance of systems that use RFID tags, antennas, and readers. It operates at multiple levels to ensure the optimal performance of readers, tags, antennae, and the information processing systems that acquire and convey tag data. The management system may employ artificial intelligence techniques such as genetic algorithms, fuzzy logic, neural networks, Bayesian networks, support vector machines or statistical methods to develop, maintain and exploit models of RFID system behavior. By comparing the actual performance of RFIDs and related components, the management system can detect and report failures and partial failures of components. The management system may also send signals to components to enhance performance of the overall RFID system.

One embodiment of the system comprises at least one radio frequency identification interrogator, a computation device, at least one radio frequency identification tag, and a set of logical instructions for the computation device directing it to monitor the signals generated by the interrogator and the tag to assess the performance of them, predict failures in them, and send correcting signals to them to maintain operation. In a minimal embodiment, the system may reside within a gate array or computer system on a chip attached to an RFID interrogator. In the embodiment later described in this document, the logical instructions of the system are executed upon a computer workstation with a graphical display. The graphical display allows a user to select different behaviors for the system, to add or remove interrogators or otherwise change the topology of the system, and to view failures and predicted failures. The system may also operate upon interrogators and other components that are automatically detected. The system examines the signals from many interrogators, interrogators with multiple antennas, groups of interrogators, multiple sites equipped with interrogators and multiple RFID tags and tag types. In this embodiment, computation of performance evaluations and failure predictions are distributed across a network of computers. In other embodiments, part or all of the function of the logical code may reside in the weights of a computation network, such as a neural network, Bayesian network, or support vector machine.

In a typical RFID system, a continuous stream of RFID tags attached to objects moves past an interrogator or interrogators. For example, a warehouse may have interrogators at its entrances. Pallets brought into and out of the warehouse have tags attached to them providing information about the pallets' contents. Interrogators, antennas, tags, networking and computing equipment are all subject to failure, potentially impairing the ability of the RFID system to properly track the contents of the warehouse. This invention monitors the signals from the RFID system's components to determine their status and overall performance from outright failures to subtle degradations in performance that may indicate pending failures or inaccurate acquisition of data. At the simplest level, the system performs the rudimentary determination if a piece of equipment is able to respond to an information request. However, a failure such as a misdirected antenna, blocked interrogation zone or intermittently failing interrogator may respond properly to such requests. To detect such failures or predict complete failures, the system gathers a log of signals transmitted by a properly operating RFID system. The system builds models from the log, in this embodiment, by using linear regression, second order autoregression, and mean and standard deviations of each period in the series of acquired data. Once models are established, the system compares the current signals from the interrogators and tags against their behavior predicted by the model. When actual performance deviates from predicted performance across certain thresholds, the system throws exceptions that can generate messages on a graphical display or send signals to interrogators or tags or other RFID system components to alter their behavior. A user of the system may use the graphical display to select which messages to display and which actions to take should threshold conditions be met. The system may also employ a neural network, fuzzy logic, decision trees, an evolutionary algorithm, a rule-based model, a support vector machine, or a Bayesian network or other statistical methods to make determinations of performance, detect failures, predict failures or produce error messages and correcting signals. In this way, the system can measure performance and can detect and report failures and partial failures of components. When the system sends signals to interrogators or tags or other RFID system components, it can change their operating behavior to compensate for detected performance deficiencies. For instance, the system may direct an interrogator to increase the power of its radio frequency signal to tags. The system may send a signal to the tags passing through the interrogator's field to alter their behavior to improve signal reception by the interrogator. The system may also present graphical messages that a human operator can use to diagnose or correct performance degradation. For instance, the system may indicate that a particular interrogator's performance has dropped below a threshold, leading a human operator to remove an obstruction to the interrogator's antenna array. In this embodiment, the system operates between the RFID system and a middleware device or savant. In other embodiments, the system may send and receive signals mediated by a middleware device. Communication between the system and interrogators may occur over a dedicated wireless or wired network or over a general-purpose network such as the Internet or a virtual private network communicated over an open network.

This invention presents the advantages of predicting failures, detecting partial failures or performance degradation, providing a status display informing human operators of performance and failures, and automatically correcting or compensating for some failures to maintain an RFID system's operation. Further it has the ability to optimize configurations based on learned behavior.

The foregoing general description and the following detailed description are exemplary and explanatory only and do not restrict the claims directed to the invention. The accompanying drawings, which are incorporated in and constitute a part of this specification, illustrate some embodiments of the invention and together with the description, serve to explain the principles of the invention but not limit the claims or concept of the invention.

### BRIEF DESCRIPTION OF DRAWINGS

FIG. 1 is a diagram illustrating the overall structure of an embodiment of the system.

FIG. 2 is a flow chart illustrating the flow of control through the portion of the logical instructions that perform monitoring.

FIG. 3 shows the equations used for performing several of the performance measurements of an RFID system.

FIG. 4 is an illustration of the data structure and its representation of the behavior of an interrogator.

FIG. 5 is a graph of data points and a linear regression line that provides a best fit for the points.

FIG. 6 is a graph of data points, a linear regression line, and the slope and intercepts for the line.

FIG. 7 is a graph of a time series with a definite non-linear trend.

FIG. 8 is a graph of a smaller segment of the curve in FIG. 7.

FIG. 9 shows the value of the available warehouse capacity variable sampled every fifteen minutes over twenty-four hours.

FIG. 10 is a graph that shows the same data of FIG. 9 with the underlying feature curves highlighted.

FIG. 11 is a graph that represents monthly and yearly behavior patterns.

FIG. 12 shows a graph of a long-term model forecasting with violations of the lower available capacity threshold.

FIG. 13 is a screen shot of the graphical interface monitor display.

FIG. 14 is a screen shot of the console display of performance and failure messages.

FIG. 15 is a screen shot of the statistical information for a selected object.

FIG. 16 is a screen shot of the audit log.

### DETAILED DESCRIPTION

The following detailed description of preferred embodiments of this invention and the attached figures are intended to provide a clear description of the invention without limiting its scope.

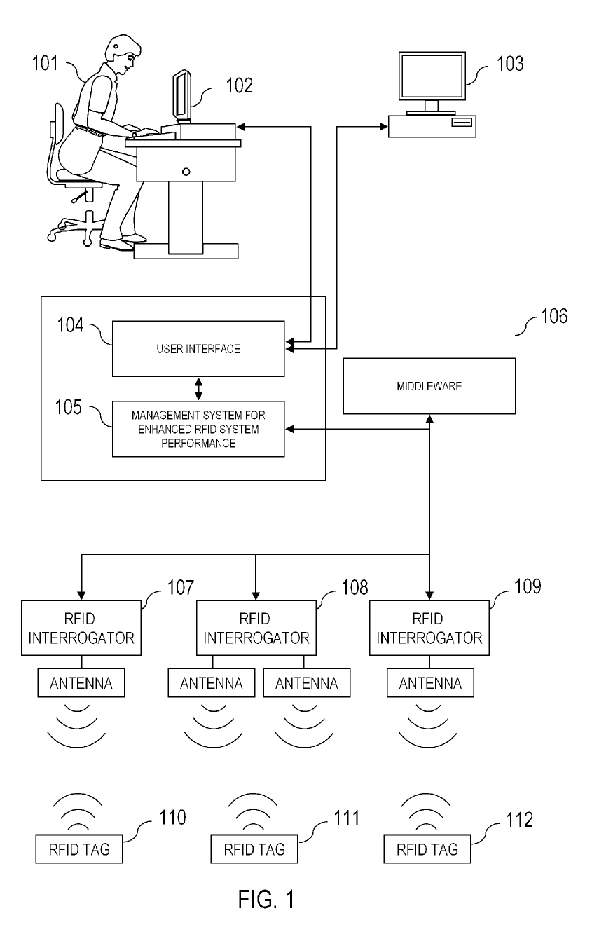

FIG. 1 is a diagram illustrating the overall structure of an embodiment of the system. A user of the system 101 accesses a computer with graphical display 102 via user interface 104. The user 101 configures the management system for enhanced RFID system performance 105 through the user interface 104. The user interface 104 may also display results of the system's monitoring and management via display 102 or monitoring console 103. The system 105 acquires signals from RFID interrogators 107-109 directly, via a data network such as the Internet, or via middleware 106. The system 105 acquires signals from RFID tags 110-112 via the RFID interrogators 107-109. The system 105 may also send signals to RFID interrogators 107-109 and RFID tags 110-112 for testing, for gathering data to build statistical models and to adjust operating parameters of these devices to improve their performance or to compensate for equipment failures.

The management system for enhanced RFID system performance performs its monitoring, performance assessment, failure prediction, and transmission of correcting signals to maintain operation by taking a broad view of monitoring. While the interrogator and its antenna or antenna array and the RFID tags form the core devices in and RFID system, expanding the focus from interrogators and tags alone provides benefits in monitoring and assessment. The behavior of a system emerges from the composite behaviors its components in ways that are often not apparent and only quantifiable over a long period of time. Objects to monitor may therefore include not only RFID interrogators, but also containers, trucks, conveyor belts, doors, and palette storage areas.

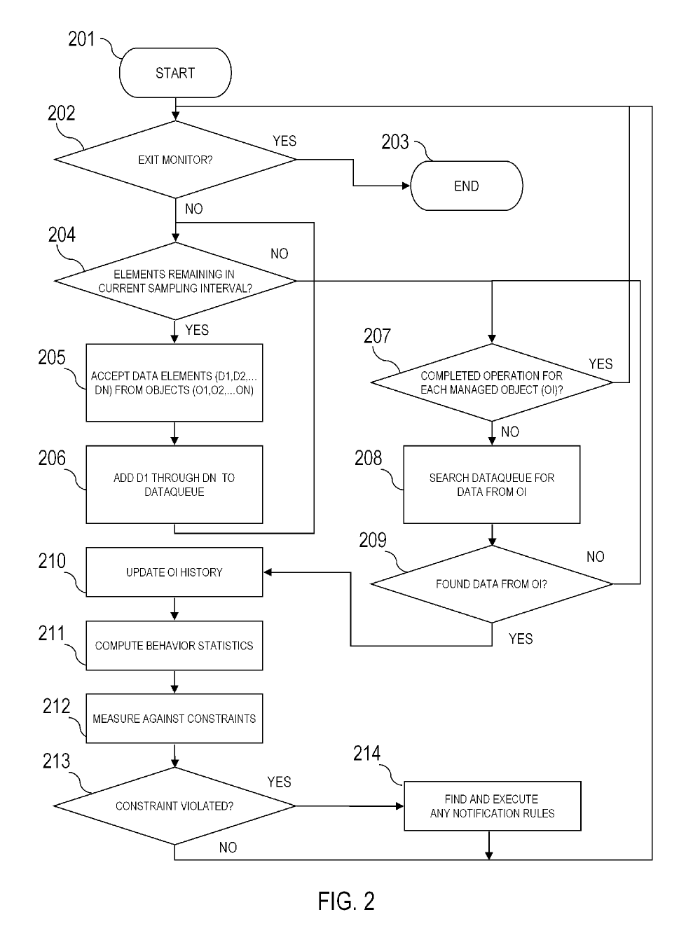

FIG. 2 is a flow chart illustrating the flow of control through the portion of the logical instructions that perform monitoring. The monitoring process initiates execution at 201 and performs a test to determine if an exit signal has been issued. If it has, then control terminates at 203. If an exit signal has not been issued to the monitoring instructions, control passes to 203, where a determination is made as to whether there are elements in the remaining in the current sampling interval. If so, execution proceeds to 205, where the logical instructions accept data elements (d₁,d₂, . . . dₙ) from objects (O₁,O₂, . . . Oₙ.). At 206 data elements d₁ through dₙ are added to the DataQueue. At 207 a new loop is initiated by testing for completed operation for each managed object (Oᵢ). If all managed objects have been processed, control returns to 202. Otherwise, control proceeds to 208 where the DataQueue is searched for data from Oᵢ. In 209 a test is performed to determine if data was found from Oᵢ. If not, then control returns to 207. Otherwise, control proceeds to 210, whereupon Oᵢ's history is updated. In 211 behavior statistics are computed based upon the new data. In 212 the behavior is measured against constraints. In 213 a test is performed to determine if constraints have been violated. If so, the logical instructions find and execute notification rules in 214. Otherwise, control returns to the outer loop 202.

In this way, for a small interval of time, the monitor collects incoming data from the readers (or any managed object). The data is stored in a queue of pending data elements (the DataQueue). After this collection phase, the data for each managed object is extracted from the queue, the object behavior profile is updated, the new behavior is checked against any implicit or explicit performance constraints, and, if a violation occurs (or is predicted to occur) then any notification rules associated with that object are executed.

In this embodiment, monitoring is a real-time or near real-time process of observing the behavior of managed objects, such as interrogators, comparing this behavior against performance metrics and sending signals to a human operator or interrogator or tag when a performance metric is either violated or about to be violated. The monitor runs in a continuous loop—reading status messages of various kinds from the objects, updating the behavior profile for each object associated with the message, and, after it has accumulated enough behavior knowledge, comparing various behavior metrics with performance tolerances.

The behavior pattern analysis is supported by a data history associated with each object—this historical vector of time-stamped data points provides the data necessary to discover statistical patterns. The cumulative data (monthly data0 is used by the rule induction engine to discover deeper trend models in the data and thus provide the basis for operational performance models. These operational rule-based models generate the signals the system transmits to the interrogators, and potentially tags, to optimize their performance and compensate for failures and partial failures.

In this embodiment, the behavior modeling function of the system is based upon both statistical learning theory and fuzzy rule induction. The behavior modeling facility learns how a managed object such as an interrogator behaves over time. The periodicity of the behavior allows the behavior analyzer to recognize what is normal for an object at different times of the day for different days of the week. The behavior patterns are evolved from the underlying data histories and provide a clear view of the periodic behaviors by day of week and time of day for each month of the year.

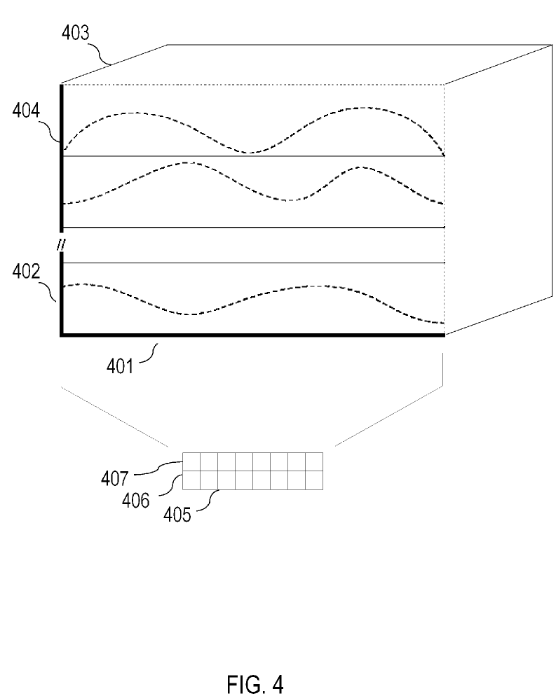

FIG. 4 is an illustration of the data structure and its representation of the behavior of an interrogator. Each of the three axes 401-403 represents a dimension of the historical data vector. 401 represents the time of day. 402 represents the day of the week. 403 represents the day of the year. Viewing a graph of the data reveals the periodicity of the interrogator's behavior. The finite depth persistent history record 404 consists of two rows. Row 405 holds date and time stamps. Row 406 holds frequency information.

The behavior pattern analysis is supported by a data history associated with each managed object. This historical vector of time stamped data points provides the data necessary to discover statistical patterns. The cumulative data (monthly data) is used by the rule induction engine to discover deeper trend models in the data and thus provide the basis for operational performance models.

This embodiment uses a predictive model based on linear regression techniques to evaluate the direction, magnitude, and rate of change in a variable. This information can be used to predict when a critical threshold will be violated. An example of a simple rule is as follows:
if X>A then SendEvent(S1); end if;
This rule says, “if the value of X in the current time period exceeds the threshold A, then send a violation event”. A lower bound is also useful for predicting capacity and performance.

This embodiment performs both short term and long term predictions. Long term prediction is performed by the application of statistical learning theory. Short term prediction provides a limited horizon forecast of near term values based solely on a small collection of historical observations.

As an objective, linear regression adjusts the values of slope and intercept to find a line that best predicts Y from X (where X is a value in the current time dimension). More precisely, the purpose of the regression is to minimize the sum of the squares of the vertical distances of the points from the line. When the sample population distribution is Gaussian or Normal (or close to a Normal distribution), two medium size deviations (say 5 units each) are more probably than one small deviation (1 unit) and one large deviation (9 units). A process that minimizes the sum of the absolute value of the distances has no preference over a line that is 5 units away from two points and one that is 1 unit away from one point and 9 units from another. The sum of the distances (more correctly, the sum of the absolute value of the distances) is 10 units in each case. On the other hand, a process that minimizes the sum of the squares of the distances prefers to be 5 units away from two points (sum-of-squares=25) rather than 1 unit away from one point and 9 units away from another (sum-of-squares=82). If the sample population is Gaussian (or nearly so), the line determine by minimizing the sum-of-squares is most likely to be correct.

A linear regression fits a line through a collection of data (say variables X and Y) such that the variances (errors) are minimized. A best straight line is generated for the data points. In a more advanced model, the slope and intercept have a specific meaning. In the short-term prediction function, however, the linear regression line is used as a standard curve to find new values of X from Y, or Y from X.

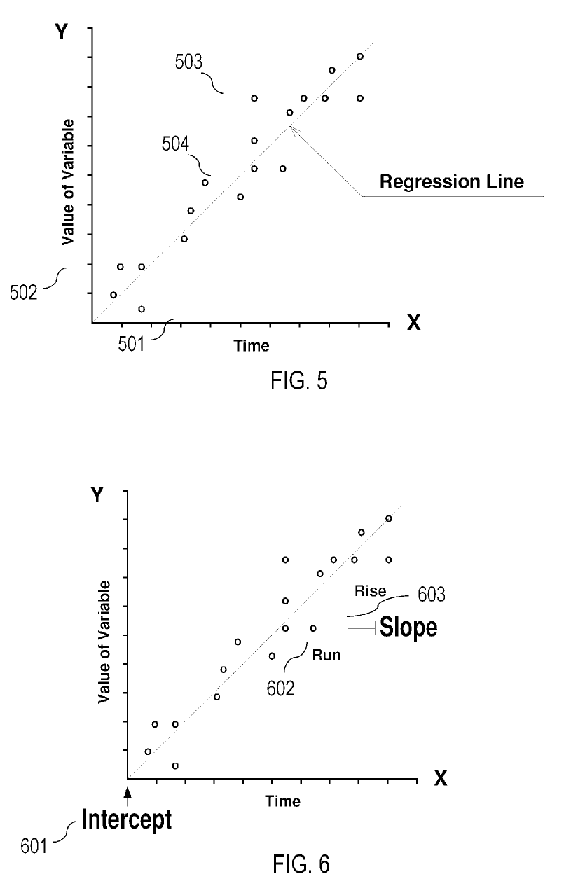

FIG. 5 is a graph of data points and a linear regression line that provides a best fit for the points. The collection of data points 503 is scattered across the X (or time) axis 501 with values displayed on Y axis 502. By using linear regression, the system constructs a reasonable model of the data's underlying short-term trend. The model generates a line 504 or curve through the data so that, by extending the line a future value of the variable is predicted.

FIG. 6 is a graph of data points, a linear regression line, and the slope and intercepts for the line. The Y-intercept 601 is the point at which the regression line intercepts the Y axis. The slope 602, is calculated as the rise 604 of the regression line for a given run 602. The slope indicates the steepness of the line and equals the change in Y for each unit change in X. If the slope is positive, Y increases as X increases. If the slope is negative, Y decreases as X increases. The equation of the line is y=a+bx where a=(sum(y)−b(sum)x)/n and b=(n*sum(xy)−sum(x)sum(y))/(n*sum(xˆ2)−(sum(x))ˆ2). In this notation, x is the current time period and n is the total number of time periods. The quantity a is the intercept and b is the slope of the line. Short-term prediction solves this least squares linear regression model in order to forecast the near term trend of a variables values.

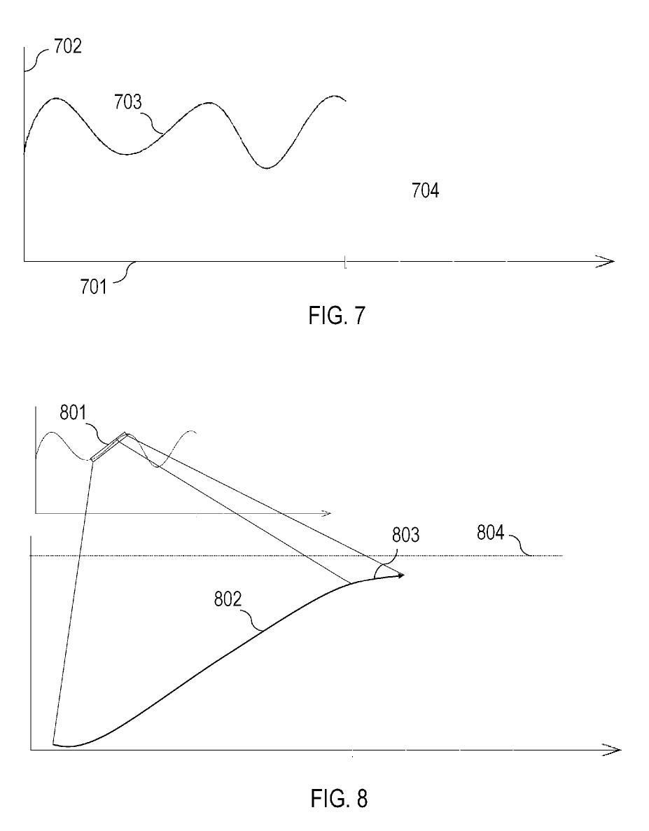

This embodiment employs short-term prediction in addition to long-term prediction because it tends to be insensitive to large-scale non-linearity in the data patterns. It is also very useful because it can be used without a prolonged learning period and without a significant amount of historical observations. FIG. 7 is a graph of a time series with a definite non-linear trend. 701 is the history (time series of X). 702 indicates values of Y for each X on the curve 703. Area 704 represents predicted future behavior. Attempting long-term prediction over this curve would lead to a large standard error. This embodiment performs short-term predictions on a small segment of the curve for greater accuracy. A sufficiently small segment appears to be linear.

FIG. 8 is a graph of a smaller segment of the curve in FIG. 7. Curve segment 801 is represented in larger form in curves 802 and 803. In the same way that the round earth appears flat over a short distance, most non-linear curves will appear flat or linear over a short distance. When this embodiment applies linear regression to segment 802, it creates an accurate forecast of values 803 over a short horizon. The degree to which the forecast is accurate is measured by examining the standard error of the estimate. If the short segment is non-linear, then the error will be high (since the predicted values along a straight line will vary significantly from the actual values following a curved line.) Values of Y over time steadily trend toward threshold line 804. Predicted behavior 803 is also moving toward the threshold 804. If it exceeds the threshold, the system throws a violation event. The objective of the variable trend prediction model is to predict the likelihood of a threshold violation at a specific time in the future and assign that likelihood a degree of certainty.

This embodiment uses the number of sampling periods in each analysis interval and the standard error associated with the model's predictive capabilities to generate an estimated time of failure (threshold violation) and assign a degree of certainty in this violation forecast.

Short-term linear regression can detect and model a trend or movement in the data over a relatively short time frame, but it cannot uncover multiple, long-term, highly non-linear movements. Detecting and modeling the long-term behavior of a time series is critical in any environment that attempts to understand normal from anomalous behaviors. Statistical pattern detection is a way of learning the behavior of a time series over a period of time. The model it creates provides the analyst and knowledge engineer with a tool to effectively understand the normal, time-dependent properties of the data by uncovering the general statistical characteristics of the data's behavior. It also allows for the recognition and use of upper and lower boundaries of the time series in the correct context—automatically finding the performance baselines for mission critical variables. I can facilitate the prediction of movement of a time series at different levels of granularity. It can establish a sound basis for intercepting and correcting anomalous behaviors before they occur. This embodiment employs two approaches for creating long-term predictive models: second order autoregression and the decomposition of a day into its hourly intervals with their associated statistical properties of mean and standard deviation.

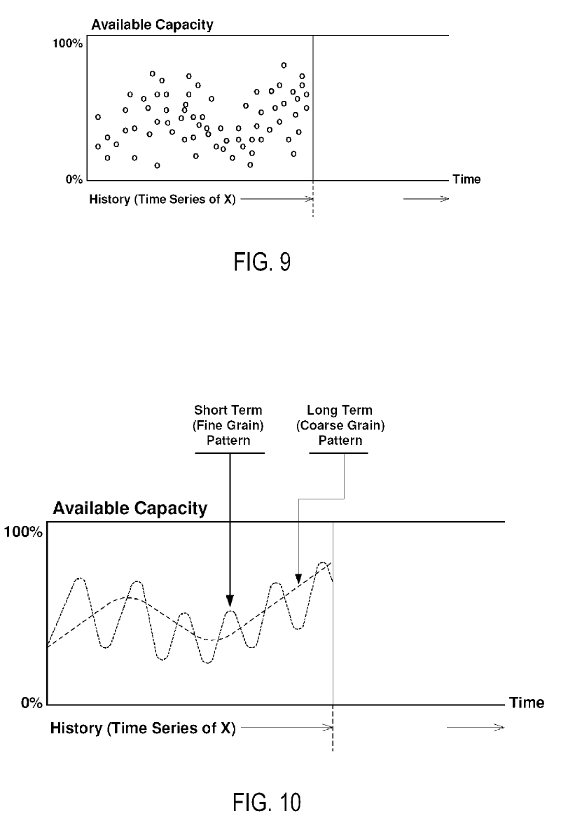

Time series variables often have many intrinsic patterns of varying amplitudes and wavelengths. A data stream containing only one or two patterns is called shallow data, while data streams that have many patterns are called deep data. In general, however, the patterns isolated by statistical learning are categorized as short term and long term. A time series can contain many short term and many long term patterns. FIG. 9 is a graph that shows the value of the available warehouse capacity variable sampled every fifteen minutes over twenty-four hours. At first glance, these values appear to be randomly scattered over the time interval with perhaps a tendency to be in the middle of the variable's domain. It is clear, though, that a linear regression would fail to capture the long-term movement of the data. In spite of this apparent tendency toward randomness, an analysis of the data reveals that the points actually fall on a repeating, sine-wave-like pattern across the time interval. FIG. 10 is a graph that shows the same data of FIG. 9 with the underlying feature curves highlighted. This embodiment removes noise from the model to isolate a more precise pattern of behavior of the data over an interval of several weeks. The weekly pattern of the available capacity variable resembles a sine wave, represented by a short-term (fine-grain) pattern and a long-term (coarse-grain) pattern.

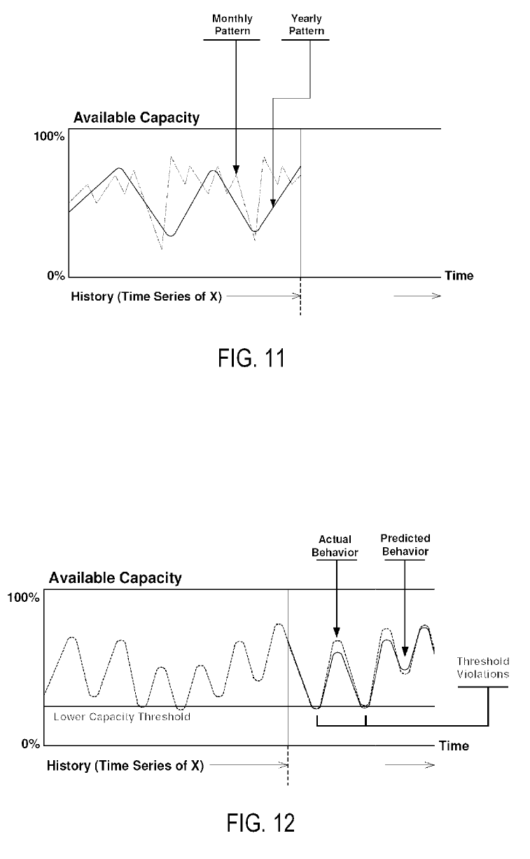

FIG. 11 is a graph that represents monthly and yearly behavior patterns. This embodiment extends the time frame further to gather patterns that are detectable at a higher level of granularity. As FIG. 11 illustrates, the data of FIG. 9 holds a monthly pattern and a yearly pattern. By accounting for noise in the model, this embodiment can detect the actual trend line over the analysis time horizon. This discovery takes the form of a (usually) non-linear model of the variable's behavior. Knowing this past behavior and using the model equations, this embodiment predicts the future behavior of the variable. The certainty of the prediction depends on several factors. Among these factors are the compactness of the underlying patterns (the amount of randomness in the behavior), the depth of the historical base (how much past data is available for pattern discovery), the amount of error in the model (how well the model represents the actual patterns), and how far into the future the variable is predicted (the further in the future, the lower the certainty.).

Once this embodiment creates the models, it predicts the behavior of the time series for some period of time in the future. Unlike the short-term model, the longer-term models can handle highly non-linear data and can be viewed at various levels of granularity. Like the short-term model, the longer-term models generate a collection of statistics about future values. In addition to the date and time, the models calculate a standard error of the estimate. When threshold boundaries are constructed, the model forecasts for threshold violations. FIG. 12 shows a graph of a long-term model forecasting with violations of the lower available capacity threshold. This embodiment creates a forecasted object that indicates not only the value and time, but also the probability that a threshold will be violated. This limits the occurrence of false positive warning messages and corrective signals.

This embodiment's long-term and short-term models can be applied to any of the system variables that change over time. In addition, other status calculations are useful in determining the performance of RFID systems:

An object, such as an interrogator, is deemed to be in an active state if it has been sending (or receiving) messages such as transponder signal events in the current sampling period, or if it has been sending messages over the past several time periods. The number of time periods can be set by a system user.

An object is deemed to be in an inactive or idle state if it has not sent or received any messages in the current time period. An object is also idle if its message traffic is very low and random over the past several time frames.

An object is deemed to be failing if two conditions are met. The ratio of error responses to successful messages has been steadily increasing over the past few sampling periods—the regression analysis of the error ratio trend line begins after four sampling periods. The ratio of total error responses to total messages is high and relatively steady over the past few periods, or the statistical measure of the message stream has a close approximation to white noise.

An object is deemed to have failed when it is only receiving error responses. An object has also failed when related objects in the RFID system are receiving messages at level X, but the object is either not receiving messages or has a wide (and perhaps random) variance from X.

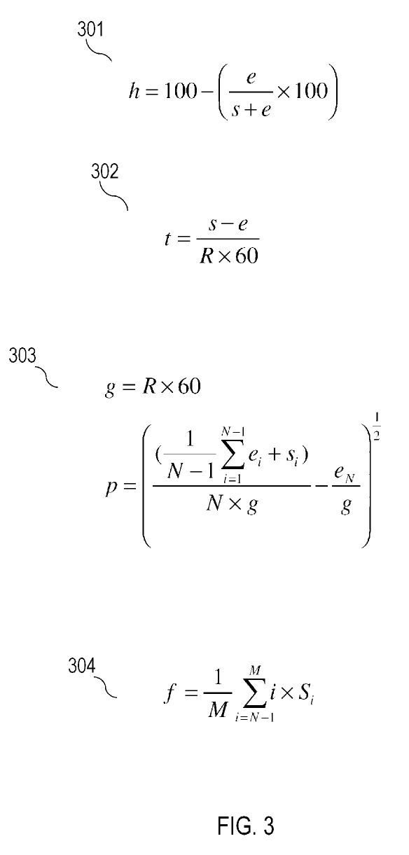

FIG. 3 shows the equations used for performing several of the performance measurements of an RFID system. The health value for this variable is based on the count of successful and error messages received during the sample period and is calculated as equation 301. The variable ‘e’ is the count of error messages and ‘s’ is the count of successful messages. When ‘e’ is small, the health will be close to 100. As ‘e’ increases the corresponding value of health decreases. The through-put variable ‘t’, calculated as 302, measures the average volume per unit time that is being processed by the interrogator (or other object). The variable ‘R’ is the sampling period in minutes (by default 2). The variable ‘p’ calculated in 303, is the difference between the current potential message volume per unit of time and the average successful message volume per unit of time. Throughput then, is the capacity measure of an interrogator when it is working. The variable ‘g’ is the total seconds in a sampling period. We thus increase our analysis granularity. The variable ‘N’ is the number of sampling periods that have elapsed from the start of the monitor to the previous sampling period. The average per second volume of all messages over the sampling horizon is taken as the potential traffic volume for the interrogator under its current operating conditions. The difference between this and the volume of successful messages in the current period, ‘N’, is a measure of its performance capacity. This can be viewed as the limit on the interrogator's ability to process incoming work and also as the amount of potential headroom available to absorb new work. The forecast variable is the weighted average slope of the second order regression lines drawn continuously through M previous time periods. The slope is weighted by time—recent sampling time periods have a higher weight than older time periods, thus making the forecast more sensitive to current trends but still responsive to relatively long term trends. The forecast variable value is calculated as 304, where ‘S’ is the regression slope. The variable ‘N’ is the number of sample periods. The slope, when coupled with either the thresholds or the performance capacity measurements will provide an early warning system—telling the operations staff when a reader (as an example) is about to fail or run out of capacity.

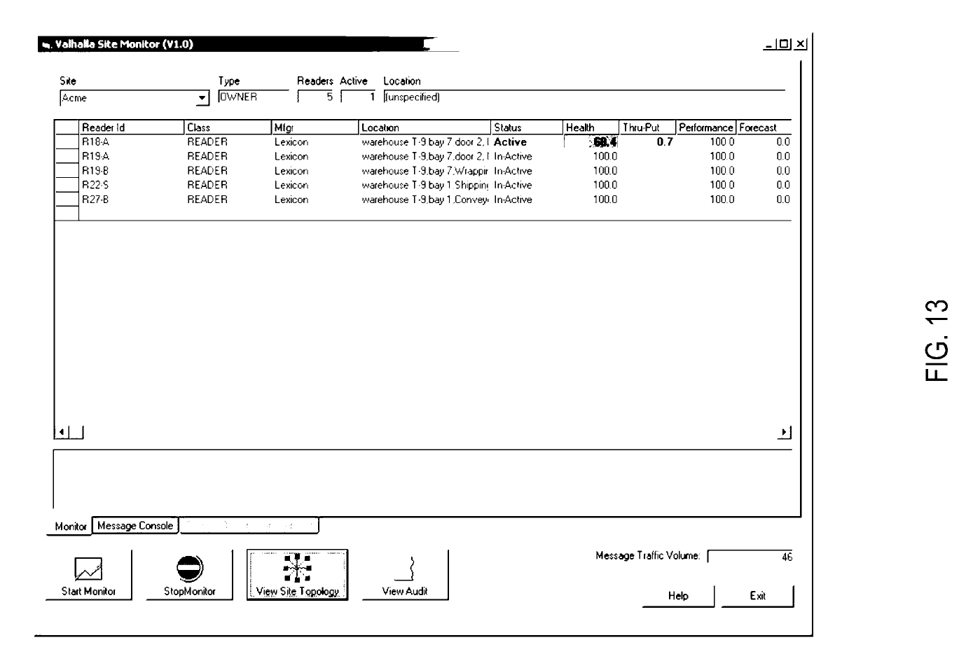

The monitoring function keeps an array of objects, such as RFID interrogators, that are monitored, displays their status on a graphical display. FIG. 13 is a screen shot of the graphical interface monitor display. The monitor reflects the activity of a set of interrogators at a particular warehouse. The display presents an interrogator (or reader) ID, the class of object being monitored, its manufacturer, its location, its status, its health, throughput, performance and a forecast calculated by the already disclosed models.

Additional statistical information for each value is displayed when a user selects an individual value through the graphical interface. FIG. 15 is a screen shot of the statistical information for a selected object. Statstics and performance graphs for all the successful reads or error reads can be displayed in the form of a graph for a given time interval (default is thirty minutes.). This display shows the total messages received divided by the sampling time converted to seconds. The display shows the Stop Periods, calculated as the number of periods in which no messages were received. The display shows the Stop To Active Ratio, calculated as the number of stopped periods over the number of active periods.

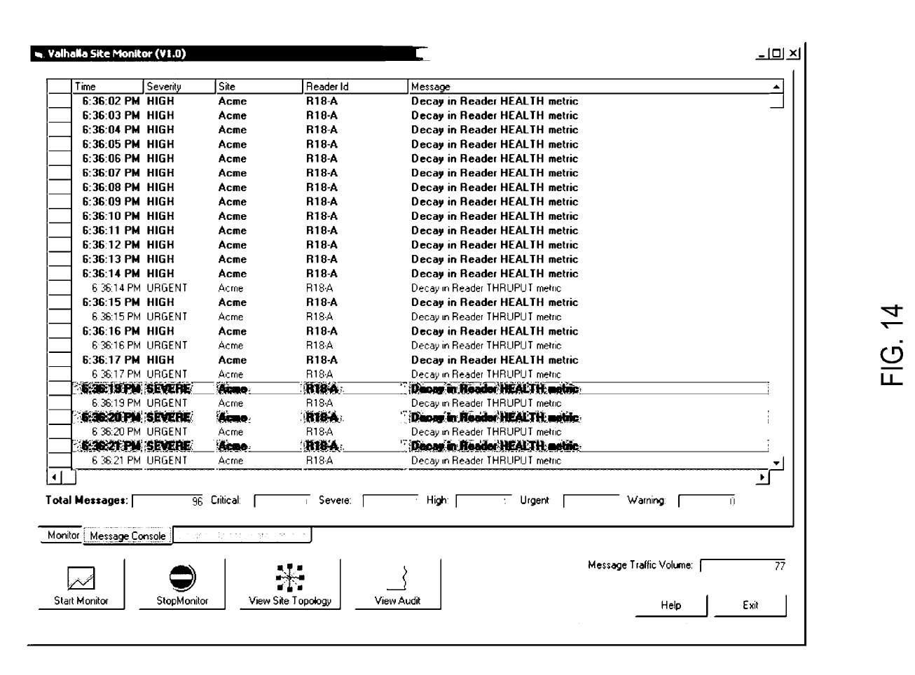

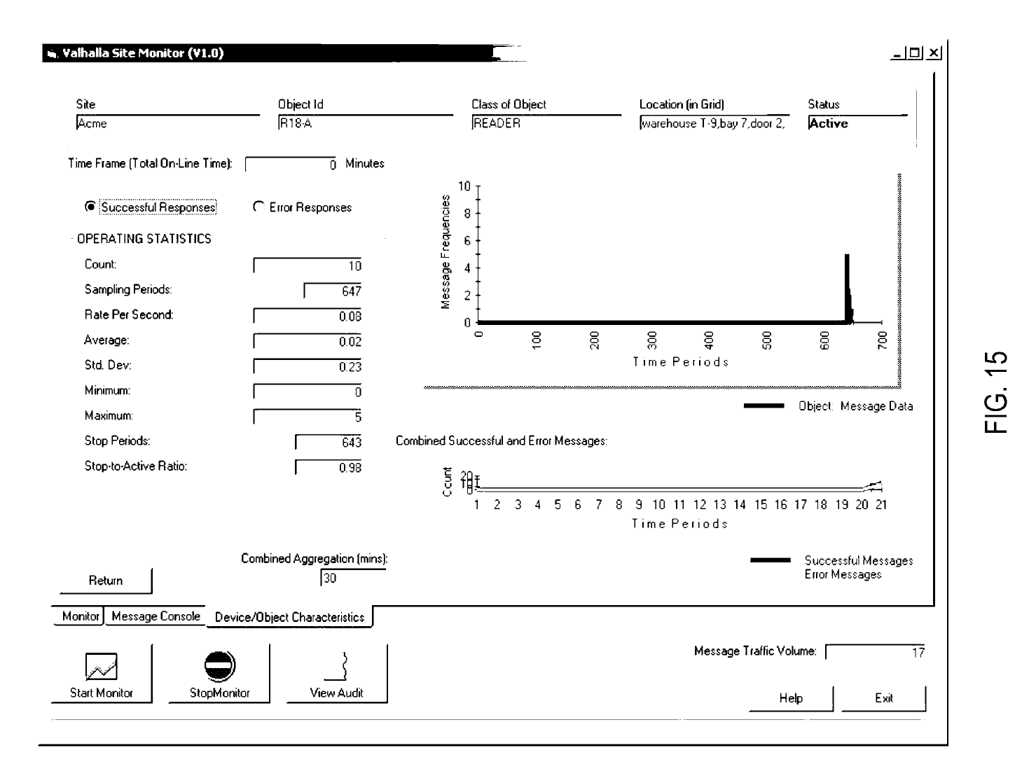

Multiple monitors may be distributed about an organization. Their messages are transmitted to a console. FIG. 14 is a screen shot of the console display of performance and failure messages. The messages are color-coded (shaded in FIG. 14) to highlight their severity. Critical events are sorted to the top of the console. Every five minutes, the severity of all other unhandled events is slightly increased—causing them to percolate to the top of the console.

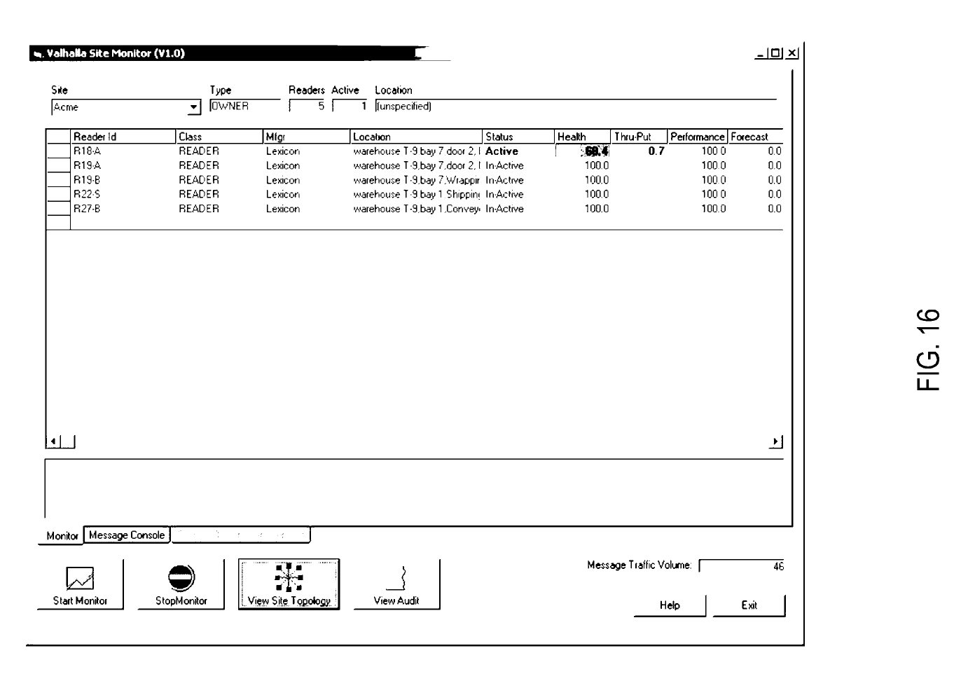

FIG. 16 is a screen shot of a sample audit log of incoming monitor messages. This allows a user to examine past monitor events to diagnose problems.

Other embodiments of the invention will be apparent to those skilled in the art from their consideration of the specification and practice of the invention disclosed in this document. The applicant intends that the specification and examples be considered as exemplary only, with the true scope and spirit of the invention being indicated by the following claims.

What is claimed is:

1. A system for managing radio frequency identification systems comprising:
one or more radio frequency identification interrogators;
a computation device;
one or more radio frequency identification tags;
and a set of logical instructions for the computation device directing it to monitor the signals generated by one or more interrogators and one or more tags to assess their performance, detect their failures, predict their failures, and send correcting signals to them to maintain operation.

2. A system according to claim 1 wherein the logical instructions determine a failure or pending failure of one or more interrogators and one or more tags by means of at least one of a neural network, fuzzy logic, a decision tree, an evolutionary algorithm, a rule-based model, a support vector machine, and a Bayesian network.

3. A system according to claim 1 wherein the signals communicated between the computation device and one or more interrogators are transmitted first to a middleware application.

4. A system according to claim 1 wherein the signals communicated between the computation device and one or more interrogators are transmitted across a data network such as the Internet.

5. A system according to claim 1 wherein the signals communicated between the computation device and one or more interrogators effect a change in the operating parameters of one or more interrogators.

6. A system according to claim 1 wherein the signals communicated between the computation device and one or more interrogators effect a change in the operating parameters of one or more tags.

7. A system according to claim 1 wherein the assessed performance is made available to human inspection via a visual display.

8. A system according to claim 1 wherein the logical instructions to send correcting signals may be selected by a human operator.

9. A system according to claim 1 wherein the correcting signals may direct actions to be carried out by a human operator.

10. A system according to claim 1 wherein the computation device is hardwired in the form of at least one of a computer system on a chip, a gate array, and an EEPROM.

11. A system according to claim 1 wherein the computation device is a computer workstation.

12. A system according to claim 1 wherein the computation device is a distributed network of computers.

13. A system according to claim 1 wherein the signals of the system are mediated by middleware for operating radio frequency identification systems.

14. A system according to claim 1 wherein a fraction of the signals of the system are communicated to middleware for operating radio frequency identification systems.

15. A system according to claim 1 wherein the logical instructions consist entirely of weights in at least one of a neural network, Bayesian network, and a support vector network.

16. A system according to claim 1 wherein the logical instructions consist in part of weights in at least one of a neural network, Bayesian network, and a support vector network.

17. A system according to claim 1 wherein the logical instructions may be directed to operate upon one or more interrogators by a human operator.

18. A system according to claim 1 wherein the logical instructions automatically detect and operate upon additional interrogators.

19. In a system for managing radio frequency identification systems including one or more radio frequency identification interrogators, a computation device, one or more radio frequency identification tags and a set of logical instructions for the computation device, a method comprising:
monitoring the signals generated by one or more interrogators and one or more tags;
assessing the performance of one or more interrogators and one or more tags;
detecting failures of one or more interrogators and one or more tags;
predicting failures in one or more interrogators and one or more tags;
and sending correcting signals to one or more interrogators and one or more tags to maintain operation.

20. A method according to claim 19 wherein assessing the performance of one or more interrogators and one or more tags is performed by comparing the series of monitored signals against that generated by autoregressive series.

21. A method according to claim 19 wherein assessing the performance of one or more interrogators and one or more tags is performed by comparing statistical indicators of the monitored signals to those previously acquired by the system.

22. A method according to claim 19 wherein assessing the performance of one or more interrogators and one or more tags is performed by feeding the monitored signals into a neural network trained on signals previously acquired by the system.

23. A method according to claim 19 wherein assessing the performance of one or more interrogators and one or more tags is performed by feeding the monitored signals into a support vector machine trained on signals previously acquired by the system.

24. A method according to claim 19 wherein assessing the performance of one or more interrogators and one or more tags is performed by feeding the monitored signals into a Bayesian network trained from signals previously acquired by the system.

25. A method according to claim 19 wherein sending correcting signals is performed by presenting information on a visual display prompting a human operator to observe and take action upon.

26. A method according to claim 19 wherein correcting signals changes the operating parameters of one or more tags.

27. A method according to claim 19 wherein correcting signals changes the operating parameters of one or more interrogators.

28. A method according to claim 19 wherein a human operator selects one or more interrogators.

29. A method according to claim 19 wherein the system automatically detects the presence of one or more interrogators.

30. A method according to claim 19 wherein the system acquires information necessary to acquire signals from one or more interrogators and one or more tags by communicating with a middleware device for radio frequency identification systems.
